(19) United States
(12) Patent Application Publication
(10) Pub. No.: US 2007/0025280 A1
(43) Pub. Date: Feb. 1, 2007

(54) Bidirectional data transmission for low-speed and high-speed communications

(76) Inventor: Byoung Woon Kim, Suwon-Si (KR)

Correspondence Address: LAW OFFICE OF MONICA H CHOI, P O BOX 3424, DUBLIN, OH, 430160204, US

(21) Appl. No.: 11/483,119

(22) Filed: Jul. 7, 2006

(30) Foreign Application Priority Data
Jul. 12, 2005 (KR) 2005-62909

(51) Int. Cl. H04B 1/56

(52) U.S. Cl. 370/276

(57) ABSTRACT

A bidirectional data transmission apparatus includes a shared channel, a client device, and a host device. The host device includes a host link interface for preparing and transmitting a check packet via the shared channel to the client device according to a high-speed communication protocol. The client device includes a client link interface for preparing and transmitting a reply packet via the shared channel to the host device according to a low-speed communication protocol, in response to the check packet.

### BACKGROUND OF THE INVENTION

This application claims priority to Korean Patent Application No. 2005-62909, filed on Jul. 12, 2005 in the Korean Intellectual Property Office, the disclosure of which is incorporated herein in its entirety by reference.

1. Field of the Invention

The present invention relates generally to data transmission, and more particularly, to bidirectional data transmission with different protocols for low-speed and high-speed communications.

2. Description of the Related Art

FIG. 1 illustrates example bidirectional data transmission in the prior art, with both data transmission Tx and data reception Rx between devices being performed via separate high-speed channels. Such a scheme advantageously uses a same link protocol for transmitting and receiving data, but disadvantageously has higher cost for the two high-speed channels and for link interfaces operating at high speed even for transmitting a relatively little amount of data.

FIG. 2 illustrates another example bidirectional data transmission in the prior art, with a high-speed channel in a forward direction and a low-speed channel in a reverse direction. Such a scheme is advantageous for lower cost since the link interfaces for the low-speed channel may operate at lower speed. However, such a scheme uses different link protocols and different hardware for the link interfaces associated with the high-speed channel versus the low-speed channel. In addition, two separate channels are still being used in FIG. 2.

FIG. 3 illustrates another example bidirectional data transmission in the prior art, with a high-speed channel that is shared for high-speed and low-speed communications. High-speed communication is established in the forward direction from device #1 to device #2, and low-speed communication is established in the reverse direction from device #2 to device #1.

For low-speed communication in the reverse direction, the scheme of FIG. 3 supports transmission of only a specific type of packet, or transmission of a field encapsulated within a packet generated according to a high-speed communication protocol. For example, the scheme of FIG. 3 uses the National Semiconductor's MPL (Mobile Pixel Link) protocol or Qualcomm's MDDI (Mobile Display Digital Interface) protocol.

In particular, according to an MDDI-based data transmission standard, a reverse packet for low-speed communication cannot be transmitted in the form of an independent packet, and thus is encapsulated into a field of a packet for a high-speed communication protocol, as illustrated in FIG. 4. Accordingly, data transmission for low-speed communication of a small amount of data in the reverse direction is limited in the prior art.

### SUMMARY OF THE INVENTION

Accordingly, data is transmitted in the forward and reverse directions (i.e., bidirectionally) via a shared channel with different protocols for low-speed and high-speed data communications, according to aspects of the present invention.

A bidirectional data transmission apparatus of an embodiment of the present invention includes a shared channel, a client device, and a host device. The host device includes a host link interface for preparing and transmitting a check packet via the shared channel to the client device according to a first protocol. In addition, the client device includes a client link interface for preparing and transmitting a reply packet via the shared channel to the host device according to a second protocol that is different from the first protocol, in response to the check packet.

In one example embodiment of the present invention, the host link interface includes a host link data processor and a host link memory device having sequences of instructions stored thereon. Execution of the sequences of instructions by the host link data processor causes the host link data processor to perform the steps of: preparing and transmitting the check packet via the shared channel to the client device according to the first protocol; and receiving and processing the reply packet according to the second protocol.

In another example embodiment of the present invention, the client link interface includes a client link data processor and a client link memory device having sequences of instructions stored thereon. Execution of the sequences of instructions by the client link data processor causes the client link data processor to perform the steps of: receiving and processing the check packet according to the first protocol; and preparing and transmitting the reply packet via the shared channel to the host device according to the second protocol, in response to receiving the check packet.

In a further embodiment of the present invention, the first protocol and the shared channel are for high-speed data communication, and the second protocol is for low-speed data communication.

In another embodiment of the present invention, the host link interface further includes a timer for determining a timing for transmitting the check packet. In that case, the timer determines the timing for transmitting another check packet from information in the reply packet, and the timer is turned on or off depending on information in the reply packet.

In a further embodiment of the present invention, the reply packet comprises command information for a payload size, a packet type, a valid flag, and a synchronization pattern. In that case, the host device includes a host data processor and a host memory device having sequences of instructions stored thereon. Execution of the sequences of instructions by the host data processor causes the host data processor to perform the steps of: ignoring the reply packet when the valid flag indicates an invalid status; and executing a command according to the packet type when the valid flag indicates a valid status.

Additionally, execution of the sequences of instructions by the host data processor causes the host processor to perform the steps of: executing a command according to packet type when the packet type indicates an immediately executable command; and receiving data of a length corresponding to the payload size from the client device, and executing a command according to the packet type using the received data, when the packet type does not indicate an immediately executable command.

In one example embodiment of the present invention, the host device is an image sensor that transmits image data to a modem that is the client device according to the first protocol, and the modem as the client device transmits control data for controlling the image sensor according to the second protocol.

In another example embodiment of the present invention, the host device is a modem that transmits processed image data to a display device that is the client device according to the first protocol, and the display device as the client device transmits control data for controlling the modem according to the second protocol. However, the present invention may also be advantageously applied for communications between other types of electronic devices.

In this manner, cost is minimized by using the shared channel for high-speed and low-speed data communications. In addition, cost is minimized by using link interfaces that are programmed to operate with a high-speed protocol for forward transmission of a large amount of data (such as for multimedia data) from the host device to the client device, and with a low-speed protocol for reverse transmission of a small amount of data (such as for control data) from the client device to the host device.

### BRIEF DESCRIPTION OF THE DRAWINGS

The above and other features and advantages of the present invention will become more apparent when described in detailed exemplary embodiments thereof with reference to the attached drawings in which:

FIG. 1 illustrates example bidirectional data transmission in the prior art, with both data transmission and reception being performed via separate high-speed channels;

FIG. 2 illustrates another example bidirectional data transmission in the prior art, with a high-speed channel in a forward direction and a low-speed channel in a reverse direction;

FIG. 3 illustrates another example bidirectional data transmission in the prior art, with a high-speed channel that is shared for high-speed and low-speed communications;

FIG. 4 illustrates a structure of packets transmitted in FIG. 3 for a mobile display digital interface (MDDI) standard, according to the prior art;

FIG. 5 shows a block diagram of a bidirectional data transmission apparatus, according to an embodiment of the present invention;

FIG. 6 shows a block diagram illustrating an example system including the bidirectional data transmission apparatus of FIG. 5, according to an embodiment of the present invention;

FIG. 7 is a flowchart of steps during operation of the bidirectional data transmission apparatus of FIG. 5, according to an embodiment of the present invention;

FIG. 8 illustrates a packet structure for the bidirectional data transmission apparatus of FIG. 5, according to an embodiment of the present invention;

FIG. 9 illustrates example reverse command (RCMD) information as transmitted from a client device in the bidirectional data transmission apparatus of FIG. 5, according to an embodiment of the present invention;

FIG. 10 illustrates example information in packets sent from the client device for transmitting a word to be written, in the bidirectional data transmission apparatus of FIG. 5, according to an embodiment of the present invention; and

FIG. 11 illustrates example information in packets sent from the client device for transmitting multiple words to be written, in the bidirectional data transmission apparatus of FIG. 5, according to another embodiment of the present invention.

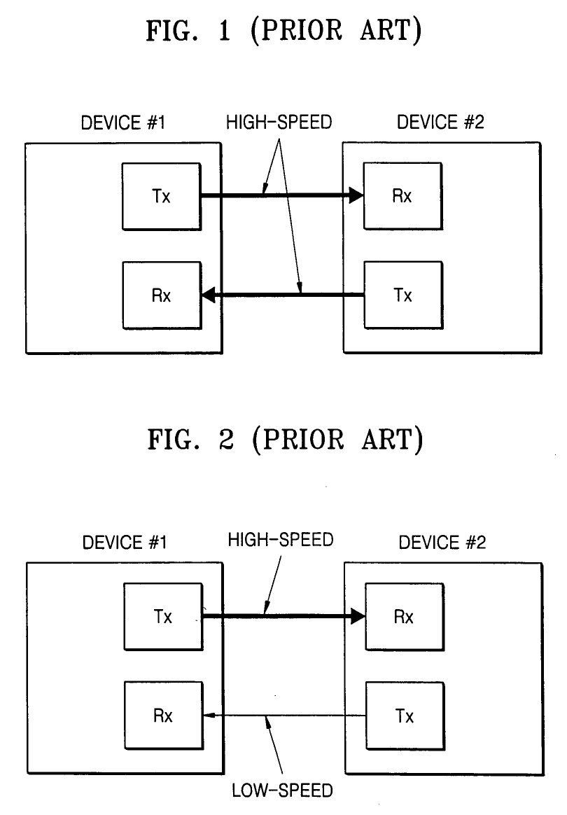

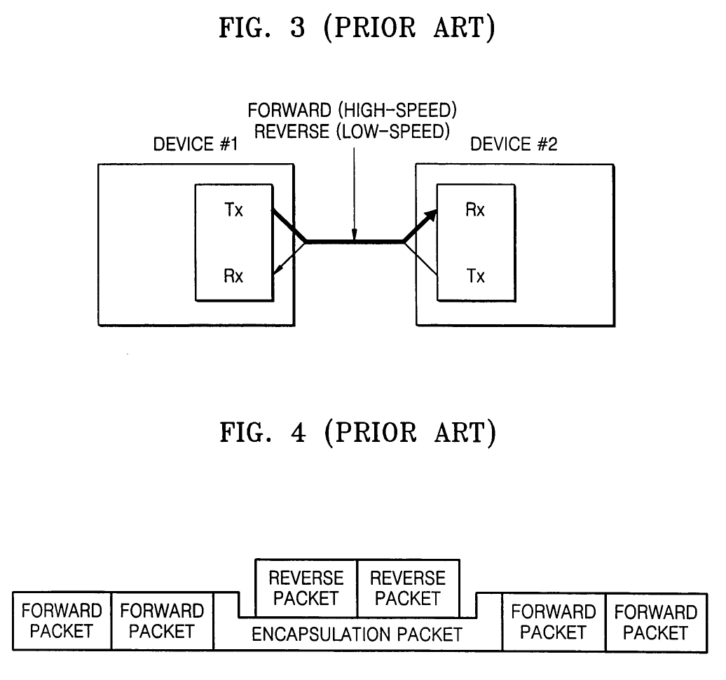

The figures referred to herein are drawn for clarity of illustration and are not necessarily drawn to scale. Elements having the same reference number in FIGS. 1, 2, 3, 4, 5, 6, 7, 8, 9, 10, and 11 refer to elements having similar structure and/or function.

### DETAILED DESCRIPTION OF THE INVENTION

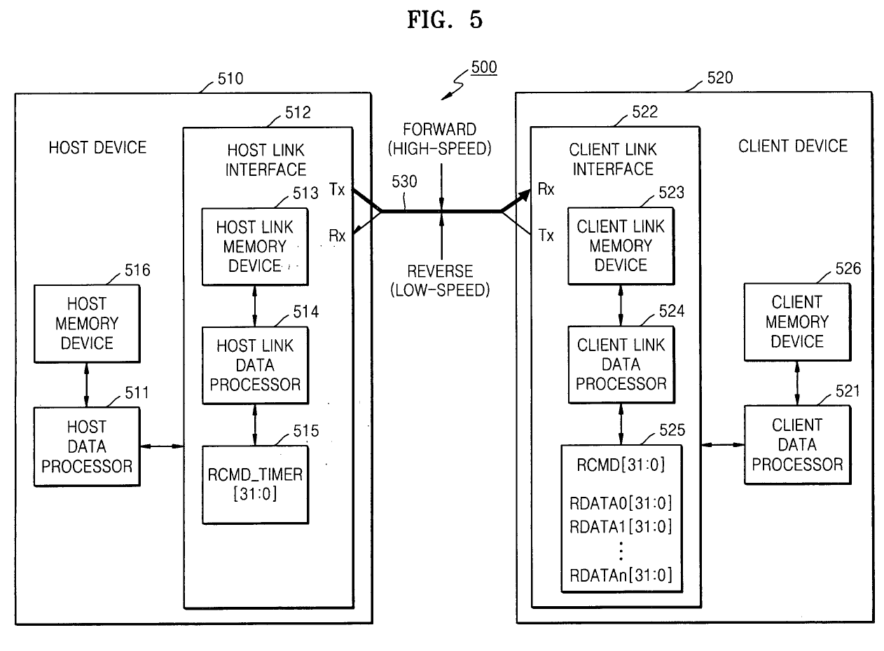

FIG. 5 shows a block diagram of a bidirectional data transmission apparatus 500 according to an embodiment of the present invention. Referring to FIG. 5, the bidirectional data transmission apparatus 500 includes a host device 510, a client device 520, and a shared channel 530.

The shared channel 530 is a high-speed channel that connects the host device 510 to the client device 520 for high-speed data communication. The channel 530 is shared for information exchange between the host and client devices 510 and 520.

Specifically, the host device 510 transmits a relatively large amount of data (such as multimedia data) as packets prepared according to a first protocol via the shared high-speed channel 530. The first protocol is for high-speed data communication, and various high-speed communications protocols individually are known to one of ordinary skill in the art.

On the other hand, the client device 520 transmits a relatively small amount of data (such as control data) as packets prepared according to a second protocol via the shared-high speed channel 530. The second protocol is different from the first protocol, and the second protocol is for low-speed data communication. Various low-speed communications protocols individually are known to one of ordinary skill in the art.

In this manner, the bidirectional data transmission apparatus 500 of FIG. 5 establishes communication in a forward direction from the host device 510 to the client device 520 for a relatively large amount of data using a high-speed communication protocol. In addition, the bidirectional data transmission apparatus 500 of FIG. 5 establishes communication in a reverse direction from the client device 520 to the host device 510 for a relatively small amount of data using a low-speed communication protocol.

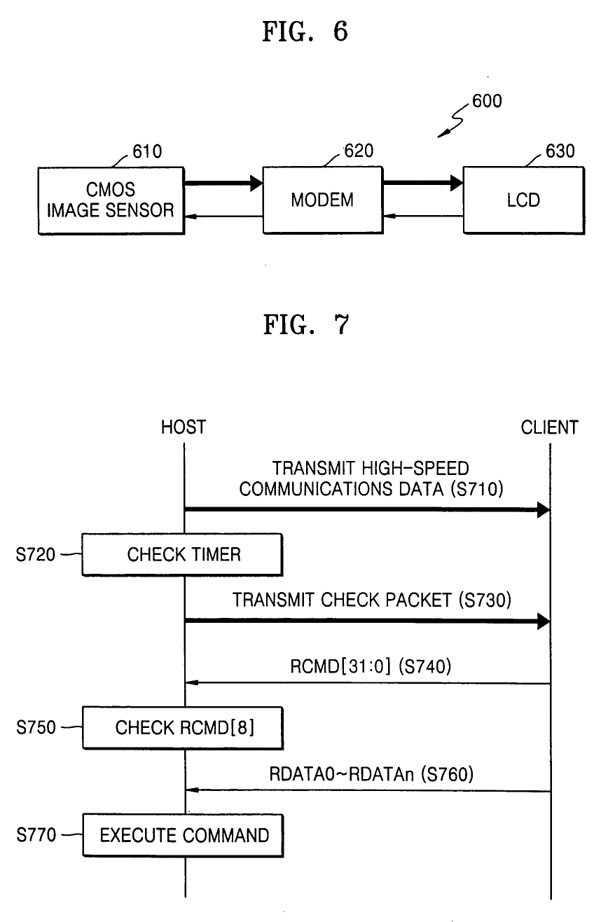

An example image pickup system 600 incorporating such a bidirectional data transmission apparatus 500 is illustrated in FIG. 6. Referring to FIG. 6, the image pickup system 600 includes a CMOS image sensor 610, a modem 620, and a display device 630 such as a liquid crystal display (LCD). The image pickup system 600 may be a digital still camera or a mobile phone camera for example.

The image sensor 610 captures an image using an active pixel sensor (APS) array having a plurality of pixels, and transmits a large amount data for the captured image to the modem 620 using the high-speed communication protocol. The modem 620 includes a data processor that processes such image data. Also, the modem 620 transmits to the image sensor 610 a relatively small amount of control data for controlling the image sensor 610 using the low-speed communication protocol. In such an example, the image sensor 610 acts as the host device 510 of FIG. 5, and the modem 620 acts as the client device 520 of FIG. 5.

Also, the modem 620 processes the image data received from the image sensor 610 according to the display standard for the display device 630. The modem 620 then transmits the processing image data to the display device 630 using the high-speed communication protocol. Furthermore, the display device 630 transmits a relatively small amount of control data to the modem 620 for controlling the modem 620 using the low-speed communication protocol. In such an example, the modem 620 acts as the host device 510, and the display device 630 acts as the client device 520.

Referring back to FIG. 5, the host device 510 includes a host data processor 511, a host memory device 516, and a host link interface 512. The host link interface 512 includes a host link data processor 514, a host link memory device 513, and a reverse command (RCMD) timer 515.

The host memory device 516 has sequences of instructions (i.e., software) stored thereon, and execution of the sequences of instructions by the host data processor 511 causes the host data processor 511 to perform any operation/function/step as described herein for the host data processor 511. The host link memory device 513 has sequences of instructions (i.e., software) stored thereon, and execution of the sequences of instructions by the host link data processor 514 causes the host link data processor 514 to perform any operation/function/step as described herein for the host link data processor 514.

The present invention may also be practiced when the host link memory device 513 is part of the host memory device 516 and/or when the host link data processor 514 is part of the host data processor 511. Although not shown, the data processor 511 may include a controller that controls the operation of the host device 510.

The client device 520 includes a client data processor 521, a client memory device 526, and a client link interface 522. The client link interface 522 includes a client link data processor 524, a client link memory device 523, and a data register 525.

The client memory device 526 has sequences of instructions (i.e., software) stored thereon, and execution of the sequences of instructions by the client data processor 521 causes the client data processor 521 to perform any operation/function/step as described herein for the client data processor 521. The client link memory device 523 has sequences of instructions (i.e., software) stored thereon, and execution of the sequences of instructions by the client link data processor 524 causes the client link data processor 524 to perform any operation/function/step as described herein for the client link data processor 524.

The present invention may also be practiced when the client link memory device 523 is part of the client memory device 526 and/or when the client link data processor 524 is part of the client data processor 521. Although not shown, the data processor 521 may include a controller that controls the overall functions of the client device 520.

The host data processor 511 generates a large amount of data to be transmitted to the client device 520. The host link data processor 514 within the host link interface 512 processes such large-amount of data and in particular generates packets for such data according to the high-speed communication protocol. The host link data processor 514 sends such packets to the client device 520 via the shared high-speed channel 530.

Additionally, the host link data processor 514 within the host link interface 512 receives and processes data received from the client device 520 via the shared channel 530 according to the low-speed communication protocol. Such received data is transmitted to the host data processor 511 for further processing.

Further referring to FIG. 5, the client data processor 521 generates a small amount of data to be transmitted to the host device 510. Such small amount of data may be control data for controlling the host device 510. The client link data processor 524 within the client link interface 522 processes such data and in particular generates at least one packet for such data according to the low-speed communication protocol. The client link data processor 524 sends such at least one packet to the host device 510 via the shared high-speed channel 530.

Additionally, the client link data processor 524 within the client link interface 532 receives and processes data packets received from the host device 510 via the shared channel 530 according to the high-speed communication protocol. Such received data is transmitted to the client data processor 521 for further processing.

The operation of the bidirectional data transmission apparatus 500 of FIG. 5 is now described in greater detail with reference to FIGS. 5 and 7. FIG. 7 illustrates a time-line of steps performed by the host device 510 and the client device 520, according to an embodiment of the present invention.

Referring to FIGS. 5 and 7, the host link data processor 514 within the host link interface 512 is transmitting data to the client device 520 via the shared high-speed channel according to the high-speed communication protocol (step S710 in FIG. 7). In addition, the host link data processor 514 checks the RCMD timer 515 during such data transmission for determining whether to transmit a reverse command (RCMD) check packet to the client device 520 (step S720 of FIG. 7).

The RCMD timer 515 is used for determining a time when the RCMD check packet is to be transmitted from the host link interface 512. When the RCMD timer 515 indicates the time for sending the RCMD check packet, the host link data processor 514 generates and transmits to the client device 520 the RCMD check packet according to the high-speed communication protocol via the shared channel 530 (step S730 in FIG. 7). Such a RCMD check packet is for inquiring whether the client device 520 has any data to be sent to the host device 510.

The client link data processor 524 within the client link interface 522 receives and processes the RCMD check packet from the host device 510 according to the high-speed communication protocol. Such processed data is transmitted to the client data processor 521.

If the client data processor 521 has a reply packet to be transmitted in response to the RCMD check packet, the data processor 521 transmits such a packet to the client link interface 522. The client link data processor 524 processes and transmits such a packet received from the client data processor 521 according to the low-speed communication protocol via the shared high-speed channel 530 to the host device 510.

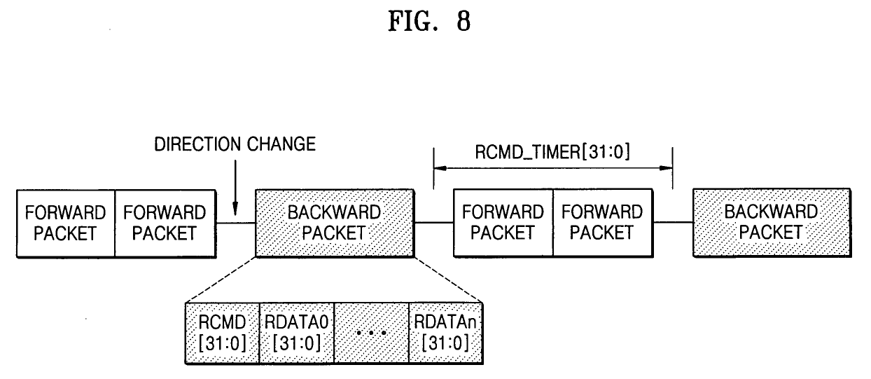

For example as illustrated in FIG. 8, RCMD (reverse command) information RCMD[31:0] is first transmitted as the reply packet to the host device 510 according to the low-speed communication protocol (step S740 in FIG. 7). Thus, in the embodiment of the present invention, the reply packet is transmitted from the client device 520 to the host device 510 according to the low-speed communication protocol which is different from the high-speed communication protocol for sending the RCMD check packet from the host device 510 to the client device 520.

The host link data processor 514 receives such a reply packet including the RCMD information RCMD[31:0] according to the low-speed communication protocol. In addition, the host link data processor 514 transmits the RCMD information RCMD[31:0] to the host processor 511 for further processing.

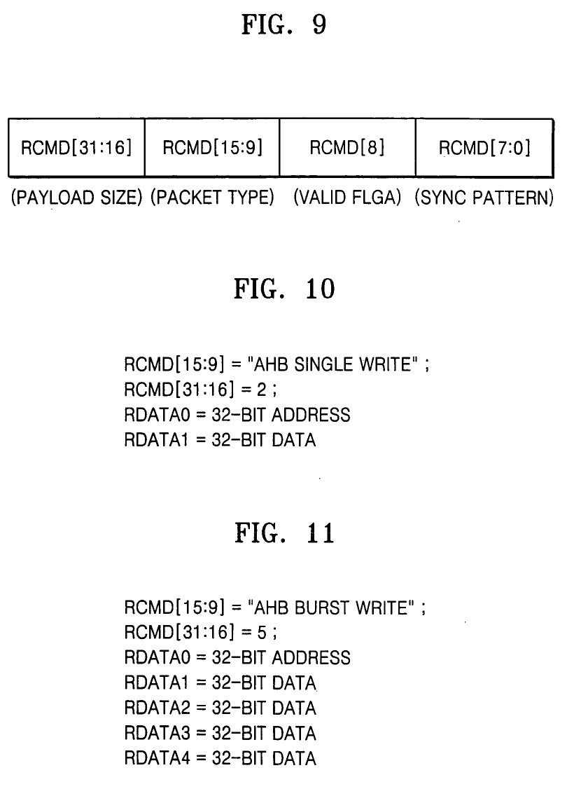

FIG. 9 illustrates example RCMD information RCMD[31:0] for the reply packet, in an example embodiment of the present invention. RCMD[31:0] in FIG. 9 includes information regarding a payload size RCMD[31:16], a packet type RCMD[15:9], a valid flag RCMD[8], and a sync pattern RCMD[7:0]. The payload size RCMD[31:16] indicates the length of payload data RDATA to be transmitted after the RCMD information RCMD[31:0]. The packet type RCMD[15:9] indicates the type of an operation to be performed on the RCMD information RCMD[31:0] and the payload RDATA subsequently received by the host device 510.

In addition, the valid flag RCMD[8] indicates whether the RCMD information RCMD[31:0] is valid. The sync pattern RCMD[7:0] is used to generate a sync signal by the host device 510. The host device 510 receives the RCMD information RCMD[31:0] and the payload data RDATA according to the timing of the sync information.

After receiving the RCMD information RCMD[31:0] in step S740 in FIG. 7, the host link data processor 514 checks the valid flag RCMD[8] according to the timing of the sync pattern RCMD[7:0] (step S750 of FIG. 7). If the valid flag RCMD[8] is not valid, the host link data processor 514 ignores the RCMD information RCMD[31:0] and the payload data RDATA. If the valid flag RCMD[8] is valid, the host link data processor 514 transmits the RCMD information RCMD[31:0] to the host data processor 511 that performs an execution for the RCMD information RCMD[31:0] according to the packet type RCMD[15:9] (step S770 in FIG. 7).

The packet type RCMD[15:9] may be information for an immediately executable command such as when the packet type RCMD[15:9] includes information for an interrupt operation to be executed by the host device 510. In that case, the host data processor 511 immediately executes an interrupt operation according to the packet type RCMD[15:9] upon receiving the RCMD information RCMD[31:0].

Alternatively, the packet type RCMD[15:9] may not be for an immediately executable command. In that case, the host link data processor 514 further receives data RDATA0, RDATA1, RDATA2, . . . , and RDATAn altogether having a length indicated by the payload size RCMD[31:16].

The host link data processor 514 receives packets for such data RDATA0, RDATA1, RDATA2, . . . , and RDATAn from the client device 520 according to the low-speed communication protocol (step S760 of FIG. 7). In addition, the host link data processor 514 transmits such data RDATA0, RDATA1, RDATA2, . . . , and RDATAn to the host data processor 511 for further processing. The host data processor 511 uses such data RDATA0, RDATA1, RDATA2, . . . , and RDATAn for executing a command indicated by the packet type RCMD[15:9].

For instance, referring to FIG. 10, when the packet type RCMD[15:9] is “AHB SINGLE WRITE” and the payload size RCMD[31:16] is 2, the data RDATA1 is stored in a register designated by an address RDATA0. Referring to another example in FIG. 11, when the packet type RCMD[15:9] is “AHB BURST WRITE” and the payload size RCMD[31:16] is 5, four words RDATA1, RDATA2, RDATA3, and RDATA4 are stored in a register starting from an address RDATA0.

In addition, the RCMD information RCMD[31:0] may also include information for operating the timer 515 to the host device 511. When the host device 511 executes the RCMD information RCMD[31:0], the timer 515 may be reset for changing a time when the host device 510 transmits another check packet, or the timer 515 may be turned on or off.

For instance, at least one predetermined bit of the RCMD information RCMD[31:0] such as RCMD[30:0] may include the value to which the timer 515 is updated for setting the time when the host device 510 transmits another check packet. Additionally, RCMD[31] may be used for indicating an on/off control value for indicating whether to turn the timer 515 on or off. Such RCMD information RCMD[31:0] may be generated in step S740 of FIG. 7 when the check packet transmitted in step S730 in FIG. 7 requests such information for controlling the timer 515.

In this manner, the high-speed channel 530 is shared for forward high-speed data transmission and reverse low-speed data transmission. Thus, cost is conserved since one channel 530 is shared. In addition, a large amount of data such as multimedia data is transmitted from the host device 510 to the client device 520 using the high-speed communication protocol. In contrast, a small amount of data such as control data is transmitted from the client device 520 to the host device 510 using the low-speed communication protocol.

The host link data processor 514 transmits packets to the client device 520 according to the high-speed protocol and receives packets from the client device 520 according to the low-speed protocol. The client link data processor 524 transmits packets to the host device 510 according to the low-speed protocol and receives packets from the host device 510 according to the high-speed protocol. Thus, data is transmitted between the host device 510 and the client device 520 with flexibility and low cost of hard-ware.

The foregoing is by way of example only and is not intended to be limiting. For example, any numbers or number of elements described and illustrated herein is by way of example only. In addition, the bidirectional data transmission apparatus 500 has been described for the image pickup system 600. However, the bidirectional data transmission apparatus 500 may advantageously be applied for data transmission between any types of electronic devices.

The present invention is limited only as defined in the following claims and equivalents thereof.

What is claimed is:

1. A bidirectional data transmission apparatus, comprising:
a shared channel;
a client device; and
a host device including a host link interface for preparing and transmitting a check packet via the shared channel to the client device according to a first protocol;
and wherein the client device includes a client link interface for preparing and transmitting a reply packet via the shared channel to the host device according to a second protocol that is different from the first protocol, in response to the check packet.

2. The bidirectional data transmission apparatus of claim 1, wherein the host link interface includes a host link data processor and a host link memory device having sequences of instructions stored thereon, and wherein execution of the sequences of instructions by the host link data processor causes the host link data processor to perform the steps of:
preparing and transmitting the check packet via the shared channel to the client device according to the first protocol; and
receiving and processing the reply packet according to the second protocol.

3. The bidirectional data transmission apparatus of claim 1, wherein the client link interface includes a client link data processor and a client link memory device having sequences of instructions stored thereon, and wherein execution of the sequences of instructions by the client link data processor causes the client link data processor to perform the steps of:
receiving and processing the check packet according to the first protocol; and
preparing and transmitting the reply packet via the shared channel to the host device according to the second protocol, in response to receiving the check packet.

4. The bidirectional data transmission apparatus of claim 1, wherein the first protocol and the shared channel are for high-speed data communication, and wherein the second protocol is for low-speed data communication.

5. The bidirectional data transmission apparatus of claim 1, wherein the host link interface further includes a timer for determining a timing for transmitting the check packet.

6. The bidirectional data transmission apparatus of claim 5, wherein the timer determines the timing for transmitting another check packet from information in the reply packet.

7. The bidirectional data transmission apparatus of claim 5, wherein the timer is turned on or off depending on information in the reply packet.

8. The bidirectional data transmission apparatus of claim 1, wherein the reply packet comprises command information for a payload size, a packet type, a valid flag, and a synchronization pattern.

9. The bidirectional data transmission apparatus of claim 8, wherein the host device includes a host data processor and a host memory device having sequences of instructions stored thereon, and wherein execution of the sequences of instructions by the host data processor causes the host data processor to perform the steps of:
ignoring the reply packet when the valid flag indicates an invalid status; and
executing a command according to the packet type when the valid flag indicates a valid status.

10. The bidirectional data transmission apparatus of claim 8, wherein the host device includes a host data processor and a host memory device having sequences of instructions stored thereon, and wherein execution of the sequences of instructions by the host data processor causes the host data processor to perform the steps of:
executing a command according to packet type when the packet type indicates an immediately executable command; and
receiving data of a length corresponding to the payload size from the client device, and executing a command according to the packet type using the received data, when the packet type does not indicate an immediately executable command.

11. The bidirectional data transmission apparatus of claim 1, wherein the host device is an image sensor that transmits image data to a modem that is the client device according to the first protocol, and wherein the modem as the client device transmits control data for controlling the image sensor according to the second protocol.

12. The bidirectional data transmission apparatus of claim 1, wherein the host device is a modem that transmits processed image data to a display device that is the client device according to the first protocol, and wherein the display device as the client device transmits control data for controlling the modem according to the second protocol.

13. A method for transmitting data between a host device and a client device, comprising:
preparing and transmitting a check packet from a host device to a client device via a shared channel according to a first protocol; and
preparing and transmitting a reply packet from the client device to the host device via the shared channel according to a second protocol that is different from the first protocol, in response to the check packet.

14. The method of claim 13, further comprising:
receiving and processing the reply packet within the host device according to the second protocol.

15. The method of claim 13, further comprising:
receiving and processing the check packet within the client device according to the first protocol.

16. The method of claim 13, wherein the first protocol and the shared channel are for high-speed data communication, and wherein the second protocol is for low-speed data communication.

17. The method of claim 13, further comprising:
determining a timing for transmitting the check packet using a timer.

18. The method of claim 17, wherein the timer determines the timing for transmitting another check packet from information in the reply packet, and wherein the timer is turned on or off depending on information in the reply packet.

19. The method of claim 13, wherein the reply packet comprises command information for a payload size, a packet type, a valid flag, and a synchronization pattern.

20. The method of claim 19, further comprising:
ignoring the reply packet by the host device when the valid flag indicates an invalid status;
executing a command according to the packet type by the host device when the valid flag indicates a valid status;
executing a command according to the packet type by the host device when the packet type indicates an immediately executable command; and
receiving data of a length corresponding to the payload size by the host device from the client device, and executing a command according to the packet type using the received data by the host device, when the packet type does not indicate an immediately executable command.
